(19) United States
(12) Patent Application Publication
(10) Pub. No.: US 2016/0295501 A1
(43) Pub. Date: Oct. 6, 2016

(54) METHOD FOR PROVIDING COMMUNITY SERVICE BASED ON PROXIMITY

(71) Applicant: Electronics and Telecommunications Research Institute, Daejeon (KR)

(72) Inventors: Young Il CHOI, Daejeon (KR); Sang Ho LEE, Daejeon (KR); Hyun Joo BAE, Daejeon (KR); Yeong Jin KIM, Daejeon (KR)

(21) Appl. No.: 15/083,365

(22) Filed: Mar. 29, 2016

(30) Foreign Application Priority Data
Mar. 30, 2015 (KR) 10-2015-0044539

(51) Int. Cl. H04W 48/16; H04W 48/20; H04W 12/04

(52) U.S. Cl. CPC H04W 48/16; H04W 12/04; H04W 48/20

(57) ABSTRACT

Disclosed is a method for providing a community service based on proximity, the method including: searching for an access point (AP) provided at a specific place and having a wireless LAN identifier assigned for the event through a wireless terminal of the host, and requesting a connection to a network by inputting a security key; when the request is accepted, generating, by a service platform receiving information about the generation of the community, a community for the event through an application installed in the wireless terminal of the host, and transmitting a community ID specifying the community for the event to the application; transmitting a request for participation in the community for the event to the service platform together with participant information input through the application and the community ID; and when the request for the participation is accepted in the service platform, transmitting a participant ID to the application.

### CROSS-REFERENCE TO RELATED APPLICATIONS

This application claims priority to and the benefit of Korean Patent Application No. 10-2015-0044539 filed in the Korean Intellectual Property Office on Mar. 30, 2015, the entire contents of which are incorporated herein by reference.

### TECHNICAL FIELD

The present invention relates to a method for providing a community service based on proximity, and more particularly, to a method for providing a community service based on proximity, which temporarily provide users of wireless terminals gathered at a specific place with the same purpose with a community.

### BACKGROUND ART

A social network service or a social proximity-based community service, which are currently and widely supplied to users, means a service forming a community including a user and specific people having a predetermined relationship with the user and maintaining the community based on a wired/wireless Internet environment.

In the social network service in the related art, a user may directly register his/her personal information in a specific website for a specific purpose in a wired/wireless Internet environment, join as a member, perform a log-in process, and then perform the specific purpose.

In the social network service in the related art, when users present in the same place perform the same purpose together, there is inconvenience in that each of the users needs to perform an individual registration on a specific website providing a corresponding social network service and perform a log-on process for the performance of the same purpose. That is, there is a problem in that the social network service in the related art provides only a limited service in a situation, in which a configuration of a social community is based on a place environment (for example, propagation of specific information between members positioned in the same region and the like).

### SUMMARY OF THE INVENTION

The present invention has been made in an effort to provide a method for providing a community service based on proximity, which extemporaneously and freely configure a temporary community for people gathered in a specific place with the same purpose.

An exemplary embodiment of the present invention provides a method for providing a community service based on proximity, the method including: searching for an access point (AP) provided at a specific place and having a wireless LAN identifier assigned for the event through a wireless terminal of the host, and requesting a connection to a network by inputting a security key; when the request is accepted, generating, by a service platform receiving information about the generation of the community, a community for the event through an application installed in the wireless terminal of the host, and transmitting a community ID specifying the community for the event to the application; transmitting a request for participation in the community for the event to the service platform together with participant information input through the application and the community ID; and when the request for the participation is accepted in the service platform, transmitting a participant ID to the application.

The information about the generation of the community may include at least one of a name of the community, a place, event information, a participant information form, and the security key, and additionally include an MAC address of the AP.

The method may further include generating, by the application, a member list of participants participating in the community for the event and providing the generated member list to a possessor of the wireless terminal after the transmitting of the participant ID to the application.

The method may further include: generating a data sharing directory for storing data to be provided to the participant through the application in the service platform; uploading the data to the data sharing directory; and providing a data ID of the uploaded data to the application.

The method may further include: requesting a deletion of the community for the event from the service platform through the application by transmitting the community ID and the security key together; authorizing, by the service platform receiving the request for the deletion, the security key, and deleting the community for the event and relevant data with reference to the community ID; and transmitting a result of the deletion to the application.

The method may further include: searching for the AP having the wireless LAN identifier through a wireless terminal of the participant, and requesting a connection to the network by inputting the security key; when the request is accepted, requesting a search for the community for the event from the service platform through the application installed in the wireless terminal of the participant; when the community for the event is searched by the service platform, transmitting information related to the community for the event to the application installed in the wireless terminal of the participant; requesting a participation in the community for the event from the service platform by inputting information according to the participant information form of the community for the event and the community ID through the application installed in the wireless terminal of the participant; and when the request for the participation is accepted, transmitting information about the participant to other participants, which already participate in the community for the event.

The application installed in the wireless terminal of the participant may request a search for the community for the event by using an MAC address of the AP.

The information related to the community for the event may include at least one of the community ID, a name of the community for the event, a place, event information, directory information, data information, a participant information form, and participant information.

The participant information may include at least one of a name, affiliation, and an address of the participant according to the participant information form of the community for the event.

The method may further include: requesting download of the data to the data sharing directory through the application installed in the wireless terminal possessed by the participant of the community for the event by transmitting the data ID together; and authorizing, by the service platform, the data ID, and then providing the data to the application installed in the wireless terminal possessed by the participant according to the request for the download.

The method may further include: requesting a generation of a chat room from the service platform by transmitting the community ID and the participant ID together through the application installed in the wireless terminal possessed by the participant of the community for the event; and authorizing, by the service platform, the community ID and the participant ID, generating the chat room according to the request for the generation of the chat room, and providing an ID of the generated chat room to the application installed in the wireless terminal possessed by the participant.

The method may further include: requesting a leave from the community for the event from the service platform by transmitting the community ID and the participant ID together through the application installed in the wireless terminal possessed by the participant of the community for the event; and authorizing, by the service platform, the community ID and the participant ID, deleting the participant according to the request for the leave, and then providing a result of the request for the leave to the applications installed in the wireless terminal possessed by the participant and a wireless terminal possessed by another participant of the community for the event.

According to exemplary embodiments of the present invention, the method for providing a community service based on proximity may extemporaneously and freely configure a temporary community for people gathered in a specific place with the same purpose.

### BRIEF DESCRIPTION OF THE DRAWINGS

FIG. 1 is a diagram illustrating a configuration of providing a method for providing a community service based on proximity according to an exemplary embodiment of the present invention.

FIG. 2 is a diagram illustrating a process of generating a community in the method for providing the community service based on proximity according to another exemplary embodiment of the present invention.

FIG. 3 is a diagram illustrating a process of sharing data in the method for providing the community service based on proximity according to another exemplary embodiment of the present invention.

FIG. 4 is a diagram illustrating a process of deleting a community in the method for providing the community service based on proximity according to another exemplary embodiment of the present invention.

FIG. 5 is a diagram illustrating a process of participating in a community generated in the method for providing the community service based on proximity according to another exemplary embodiment of the present invention.

FIG. 6 is a diagram illustrating a process of receiving shared data in the method for providing the community service based on proximity according to another exemplary embodiment of the present invention.

FIG. 7 is a diagram illustrating a process of generating a chat room in the method for providing the community service based on proximity according to another exemplary embodiment of the present invention.

FIG. 8 is a diagram illustrating a process of leaving a community in the method for providing the community service based on proximity according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Advantages and features of the present invention and methods of achieving the advantages and features will be described with reference to exemplary embodiments described in detail below together with the accompanying drawings. However, the present invention is not limited to the exemplary embodiments described herein, and may be implemented in various different forms. However, the exemplary embodiments described herein are provided so as to describe the present invention in detail so that those skilled in the art may easily carry out the technical spirit of the present invention.

In the drawings, the exemplary embodiments of the present invention are not limited to the illustrated specific forms, but are exaggerated for the purpose of clarity. Herein, specific terms have been used, but are just used for the purpose of describing the present invention and are not used for defining the meaning or limiting the scope of the present invention, which is disclosed in the appended claims.

In the present specification, the term “and/or” is understood to include at least one of the constituent elements that are enumerated in the context. Further, an expression of “connected/coupled” is used as a meaning including a direct connection with another constituent element or an indirect connection through another constituent element. Unless particularly stated otherwise in the present specification, a singular form also includes a plural form. Further, a constituent element, a step, an operation, and a device mentioned with “include” or “including” used in the specification mean existence or addition of one or more other constituent elements, steps, operations, and devices.

Hereinafter, an exemplary embodiment of the present invention will be described in detail with reference to the accompanying drawings.

Currently, mobile messengers and websites providing an SNS service configure communities based on telephone numbers or IDs of known existing people and provide a community service based on proximity As a result, it is impossible to configure a temporary community based on the same place and the same purpose.

For example, if it is possible to freely configure a temporary community for people gathered in a specific place with the same purpose, such as a community based on participants of a specific conference, it is possible to provide a communication service, which enables community participants to share data necessary for the corresponding conference, the community participants to provide necessary information with each other, and enables the participants of the conference to exchange information.

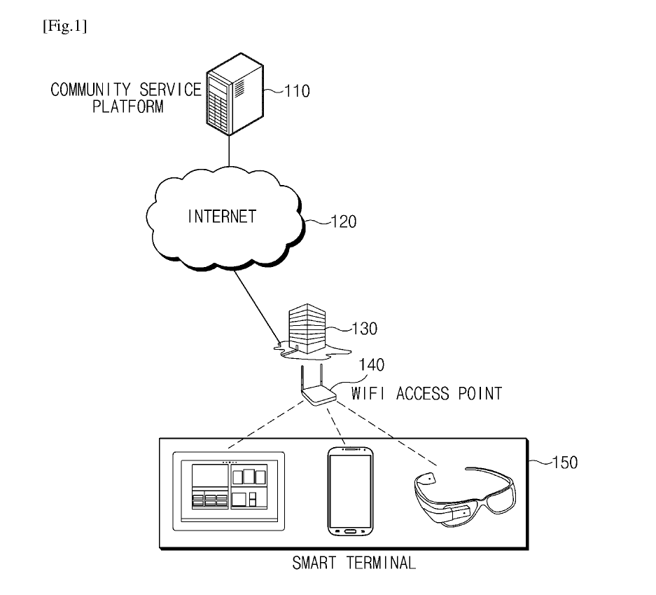

FIG. 1 is a diagram illustrating a configuration of providing a method for providing a community service based on proximity according to an exemplary embodiment of the present invention. Referring to FIG. 1, the method for providing the community service based on proximity includes a proximity-based community service platform 110, a network 120 (for example, the Internet), a WiFi access point 140, and a wireless terminal 150 (hereinafter, referred to as a “wireless terminal”).

The proximity-based community service platform 110 generates a temporal and extemporaneous community for an event for users of wireless terminals gathered in a specific place for the same purpose, controls the generated community, and manages the wireless terminals of participants participating in the community for the event. Further, the proximity-based community service platform 110 generates and manages a directory for sharing data between members of the community, and manages community participation histories of the participants.

The proximity-based community service platform 110 may control a community service based on proximity for the event in connection with a proximity based community service application program (hereinafter, referred to as an “application”) installed in wireless terminals of the participants and a host, and provide a multimedia message service, a video call service, and the like between the participants of the community for the event.

The network 120 is a communication environment provided by a communication business operator and an internet service provider (ISP) for the participants and the host using the wireless terminals, and the WiFi access point 140, which is a wireless sharer installed in a specific place 130, in which an event for a specific purpose is held, is a device enabling a wireless terminal to access the network 120 by using a WiFi wireless communication technology. A wireless LAN identifier (SSID) of the WiFi access point 140 and a security key of the corresponding network 120 may be set by the host of the event.

The wireless terminal 150 is a user terminal capable of accessing the network by using the WiFi wireless communication technology, and includes a communication module providing an Internet access function, an input/output module, a calculation processing module, a storage module, and the like, and provides an environment in which the application is executed. Here, the application is installed in the wireless terminal 150 of the participant and provides a user interface for using the proximity based community service for the event, and controls the proximity based community service for the event and provides a multimedia message service, a video call service and the like between the participants of the community in connection with a proximity based community service platform (hereinafter, referred to as a “service platform”).

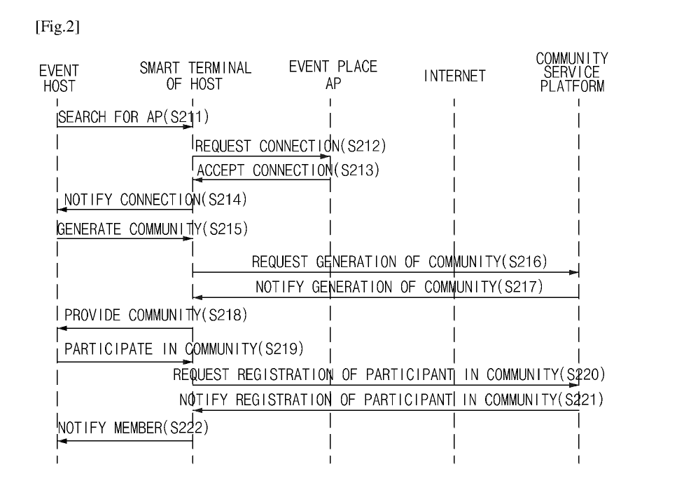

FIG. 2 is a diagram illustrating a process of generating a community in the method for providing the community service based on proximity according to another exemplary embodiment of the present invention.

First, a host searches for a WiFi access point having a wireless LAN identifier assigned for a corresponding event by using a wireless terminal in a place, in which an event for a specific purpose is held (S211), and inputs a network security key and makes an access request for a connection to the Internet (S212).

Then, when the access request for the WiFi access point for the corresponding event is accepted (S213), the wireless terminal of the host notifies the host of the event of the connection to the Internet (S214). The host of the event executes an application installed in the wireless terminal, and inputs a name of a community for the event, a place, event information, a participant information form, a security key, and the like for the corresponding event by using a community generating function provided by the application (S215). Here, the corresponding application may be downloaded from an application market and be installed in the wireless terminal.

The application adds an MAC address of the WiFi access point to the data input by the host of the event, and requests the generation of the community for the event from a service platform by using an HTTP protocol (S216).

The service platform receiving the request for the generation of the community for the event generates the community for the specific event by using the received data, and transmits a community ID specifying the generated community for the event to the application (S217).

The application provides the generated community to the host of the event through a user interface screen based on the received community ID (S218).

The host of the event may confirm the community generated in the application, and input a “participant name/affiliation/address” and the like according to the participant information form of the community by using a community participation function provided by the application and participate in the community (S219).

The application transmits the input participant information to the service platform together with the community ID and requests an addition of a new participant to the corresponding community for the event (S220).

The service platform receiving the community participation request searches for the corresponding community by using the received community ID, registers the participant, of which the addition has been requested as a member, to the members of the community, and notifies the application of an ID of the participant as a result of the registration (S221).

The application generates a list of the participants participating in the community for the event based on the received participant ID, and provides a result of the generation to the host of the event (S222).

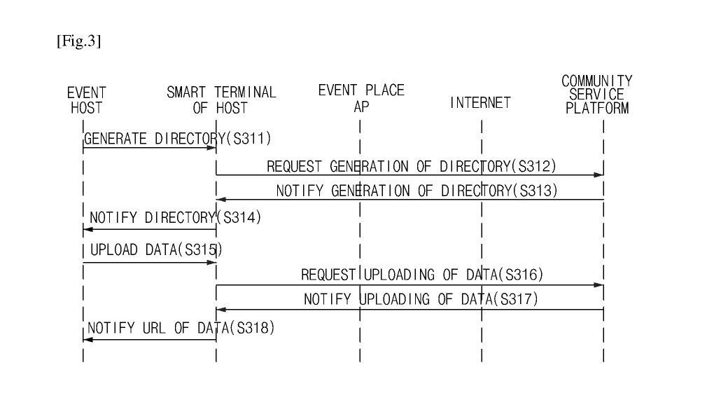

FIG. 3 is a diagram illustrating a process of sharing data in the method for providing the community service based on proximity according to another exemplary embodiment of the present invention.

The host of the event may generate a data sharing directory for storing data to be provided to participants of an event by using a directory generating function provided by an application (S311).

The application requests the generation of the directory having a name demanded by the host of the event from a service platform by using an HTTP protocol by adding a community ID to the directory name input by the host of the event (S312).

The service platform receiving the directory generation request generates the directory by using the received directory name and community ID, and transmits a directory ID specifying the generated directory to the application (S313).

The application provides a fact that the directory is generated in the community for the event based on the received result to the host of the event (S314).

The host of the event may confirm the directory generated within the community for the event of the application, and store data to be provided to the participants of the community for the event in the generated directory by using a data upload function provided by the application (S315).

The application adds the directory ID to the data input by the host of the event, and requests the transmission of the data, which is demanded to be stored by the host of the event, and the storage of the corresponding data from the service platform (S316).

The service platform receiving the data storage request searches for the corresponding community and directory, stores the received data, and transmits a data ID specifying the stored data to the application (S317). Here, the data ID may be a URL.

The application expresses a sharing data URL in the directory based on the data ID, and provides the sharing data URL to the host of the event (S318).

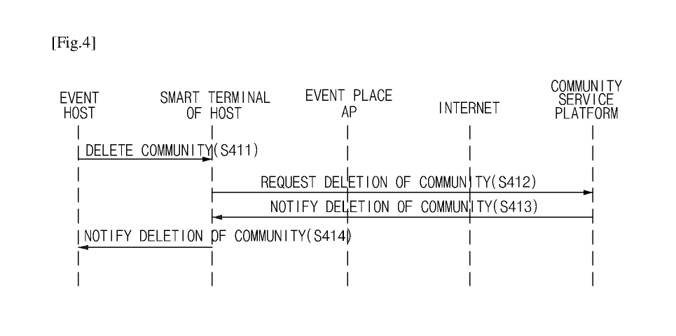

FIG. 4 is a diagram illustrating a process of deleting a community in the method for providing the community service based on proximity according to another exemplary embodiment of the present invention.

When an event is terminated or it is necessary to close a community for an event, a host of the event may remove the community for the event by using a community deleting function provided by the application (S411).

The application transmits a community ID, of which a removal is requested, and a security key, which is registered during the generation of the community, to the service platform, and requests a deletion of the corresponding community for the event (S412).

The service platform receiving the request for the deletion of the community for the event authenticates the community ID and the security key of the corresponding community for the event, deletes the corresponding community for the event and the related data with reference to the received community ID, and transmits a result of the deletion to the application (S413).

The application provides a fact that the corresponding community for the event is deleted based on the received result to the host of the event (S414).

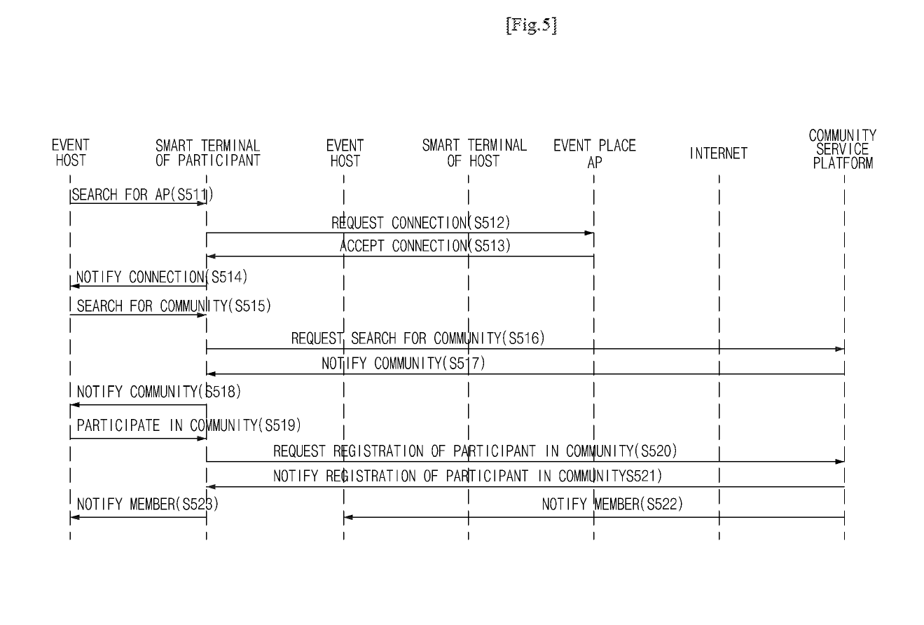

FIG. 5 is a diagram illustrating a process of participating in a community generated in the method for providing the community service based on proximity according to another exemplary embodiment of the present invention.

An event participant arriving at an event place searches for a WiFi access point having a wireless LAN identifier notified by a host of an event by using his/her wireless terminal (S511), and inputs a network security key and requests an access for a connection to the Internet (S512).

When the access request for a WiFi wireless sharer for the event is accepted (S513), the wireless terminal notifies the event participant of the connection to the Internet (S514).

The event participant may install an application notified by the host of the event in the wireless terminal and execute the application, and inquiry into existence of a community for the event by using a community searching function provided by the application (S515).

The application requests a search for the community for the event from a service platform (S516). Here, the application may request the search for the community for the event by using an MAC address of the WiFi access point.

The service platform receiving the community search request searches for the community for the event by using the received MAC address of the WiFi access point, and when the community for the event, of which the search is requested, exists, the service platform transmits a list including a community ID, a name, a place, event information, directory information, data information, a participant information form, participant information, and the like of the corresponding community for the event to the application as a result of the search (S517).

The application provides the generated community for the event to the event participant through an interface screen based on the received result of the search (S518).

The event participant may confirm the community generated in the application, and input a “name, affiliation, and an address” of a participant, and the like according to the participant information form of the community by using a community participation function provided by the application and participate in the community (S519).

The application transmits the input participant information to the service platform together with the community ID and requests an addition of a new participant to the designated community for the event (S520).

The service platform receiving the community participation request searches for the corresponding community for the event by using the received community ID, registers the participant, of which the addition is requested, as a community member, and notifies a result of the registration (S521), and transmits information about an ID, a name, affiliation, and an address of the newly joined participant to the existing participants of the corresponding community for the event and the applications installed in the wireless terminal of the host (S522).

The application generates a list of the members participating in the community based on the received result, and provides a result of the generation to the event participant through the interface screen (S523).

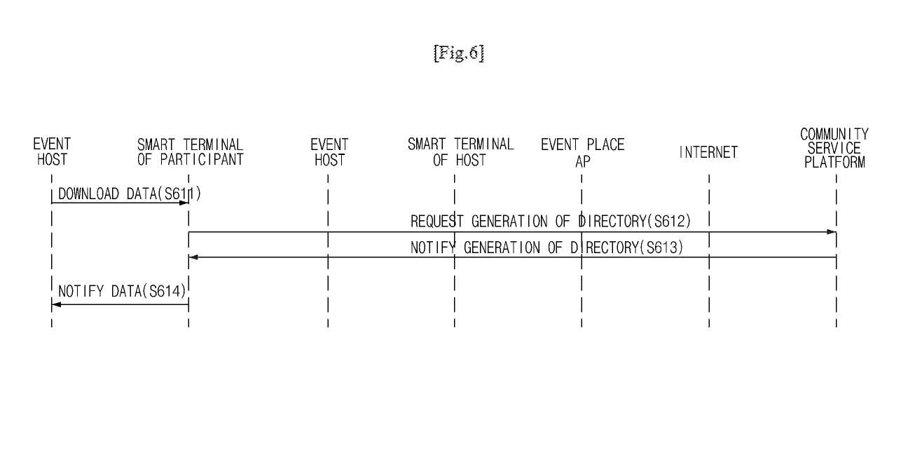

FIG. 6 is a diagram illustrating a process of receiving shared data in the method for providing the community service based on proximity according to another exemplary embodiment of the present invention.

An event participant may confirm a data sharing directory generated in a community for an event, and download necessary data by using a data download function provided by the application (S611).

The application requests download of the corresponding data from a service platform with reference to a data ID or URL of the data selected by an event participant (S612).

The service platform transmits the data corresponding to the received data ID and URL to a service application (S613). The application provides the received data to the event participant (S614).

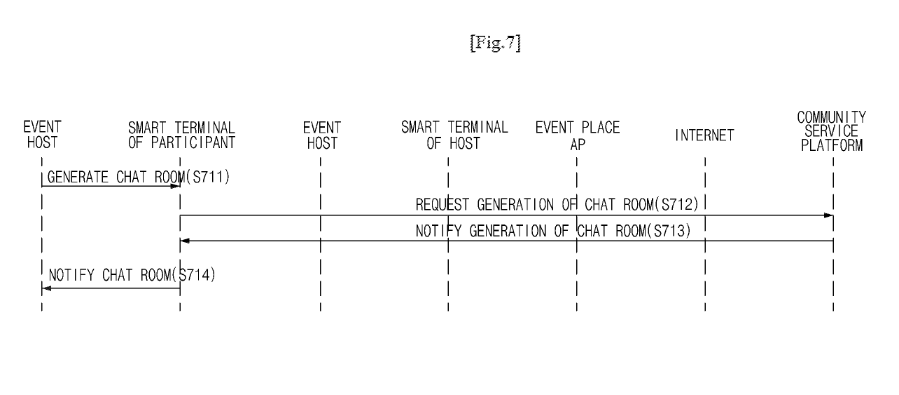

FIG. 7 is a diagram illustrating a process of generating a chat room in the method for providing the community service based on proximity according to another exemplary embodiment of the present invention.

When an event participant needs to exchange information with a specific participant within a community for an event, the event participant may select a participant, with which the event participant desires to exchange the information, from among the participants of the community for the event, generate a chat room by using a chat room generating function provided by the application (S711).

The application requests the generation of the chat room for exchanging the information between the participants of the community for the event by transmitting a community ID and an ID of a participant desiring the generation of the chat room to the service platform (S712).

The service platform generates the chat room in the corresponding community with the received community ID, and transmits an ID of the generated chat room to the application (S713).

The application provides a fact that the chat room is generated to the participant of the community for the event through an interface screen based on the received result (S714). The participant of the community for the event may exchange the information with other participants by using the chat room generated in the application.

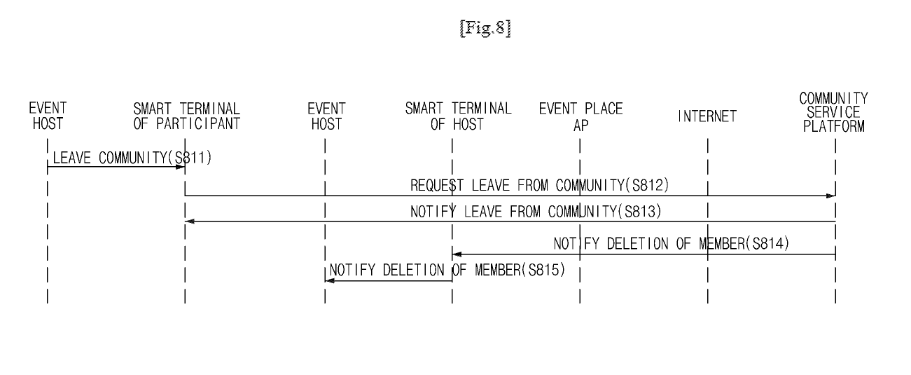

FIG. 8 is a diagram illustrating a process of leaving a community in the method for providing the community service based on proximity according to another exemplary embodiment of the present invention.

When an event participant leaves an event place, the application may not access the WiFi wireless sharer of the event place, or senses an environment using the Internet by using another MAC address, not the MAC address of the WiFi access point used during the generation of the community. In this case, the event participant may request the leaving from the community for the event (S811).

The application requests the leave from the corresponding community for the event by transmitting a community ID and a user ID to the service platform (S812).

The service platform receiving the community leave request searches for the corresponding community for the event by using the received community ID, deletes the participant, of which the leave is requested, from a community member list, and transmits a corresponding deletion result to an application installed in a wireless terminal possessed by the left participant (S813), and transmits information about the leaving user to the applications installed in the wireless terminals possessed by other participants and the host of the event, who are participating in the corresponding community for the event (S814).

The application may notify other participants of the community for the event and the host of the event of the leaving user through an interface screen based on the received user information (S815).

As a result, according to the method for providing the community service based on proximity according to the exemplary embodiment of the present invention, it is possible to provide a service, which is capable of freely configuring a temporary community between users of smart terminals gathered in a specific place for the same purpose to enable the participants to share and exchange information with each other.

Accordingly, it is possible to provide participants of a corresponding event with an extemporaneous and useful proximity-based community service, improve a new communication experience and communication convenience, and create a new type of SNS service industry.

Particularly, the service platform according to the present invention may immediately configure a temporary community between users gathered in a specific place for the same purpose as necessary to provide various mobile converged services and create an industry based on the mobile converged service.

For example, the service platform may also be used as a platform, which configures a community between users of wireless terminals in a department store and the like and provides immediate and various types of mobile social network services, such as collecting communal purchasers according to a product discount condition. Further, the service platform may be utilized as a service platform, in which a menu may be electronically provided or food may be electronically ordered in a restaurant, a cafe, and the like, and visitors visiting a private business office may exchange information with each other. Further, the service platform may configure a community between users of wireless terminals participating in a specific place, such as a seminar or a class, and provide a service, such as data provision, question and answer, and information exchange.

The service platform may configure a community by using one identical SSID regardless of the number of established APs, and variously configure the form of participant registration information according to a purpose of an event. Further, it is expected that the service platform may freely generate and remove a community for an event by a host of the event, analyze information about a purpose and a place of the event and promote related information, and be utilized as an advertisement platform.

In the above, the present invention has been described based on the particular exemplary embodiments, but it will be appreciated well that the present invention may be variously modified without departing from the scope of the present invention. Therefore, the scope of the present invention shall not be defined by the aforementioned exemplary embodiments, and shall be defined by the accompanying claims and equivalents thereof. In consideration of the aforementioned contents, if the correction and the change of the present invention belong to the accompanying claims and the equivalents thereof, it shall be considered that the present invention includes the correction and the change.

What is claimed is:

1. A method for providing participants and a host gathered in a specific place for an event of the same purpose with a community service based on proximity, the method comprising:
searching for an access point (AP) provided at the specific place and having a wireless LAN identifier assigned for the event through a wireless terminal of the host, and requesting a connection to a network by inputting a security key;
generating, by a service platform receiving information about the generation of the community, a community for the event through an application installed in the wireless terminal of the host, when the request is accepted, and transmitting a community ID specifying the community for the event to the application;
transmitting a request for participation in the community for the event to the service platform together with participant information input through the application and the community ID; and
transmitting a participant ID to the application when the request for the participation is accepted in the service platform.

2. The method of claim 1, wherein the information about the generation of the community includes at least one of a name of the community, a place, event information, a participant information form, and the security key, and additionally includes an MAC address of the AP.

3. The method of claim 1, further comprising:
generating, by the application, a member list of participants participating in the community for the event and providing the generated member list to a possessor of the wireless terminal after the transmitting of the participant ID to the application.

4. The method of claim 1, further comprising:
generating a data sharing directory for storing data to be provided to the participant through the application in the service platform;
uploading the data to the data sharing directory; and
providing a data ID of the uploaded data to the application.

5. The method of claim 1, further comprising:
requesting a deletion of the community for the event from the service platform through the application by transmitting the community ID and the security key;
authorizing, by the service platform receiving the request for the deletion, the security key, and deleting the community for the event and relevant data with reference to the community ID; and
transmitting a result of the deletion to the application.

6. The method of claim 1, further comprising:
searching for the AP having the wireless LAN identifier through a wireless terminal of the participant, and requesting a connection to the network by inputting the security key;
when the request is accepted, requesting a search for the community for the event from the service platform through the application installed in the wireless terminal of the participant;
when the community for the event is searched by the service platform, transmitting information related to the community for the event to the application installed in the wireless terminal of the participant;
requesting a participation in the community for the event from the service platform by inputting information according to the participant information form of the community for the event and the community ID through the application installed in the wireless terminal of the participant; and
when the request for the participation is accepted, transmitting information about the participant to other participants, which already participate in the community for the event.

7. The method of claim 6, wherein the application installed in the wireless terminal of the participant requests a search for the community for the event by using an MAC address of the AP.

8. The method of claim 6, wherein the information related to the community for the event includes at least one of the community ID, a name of the community for the event, a place, event information, directory information, data information, a participant information form, and participant information.

9. The method of claim 6, wherein the participant information includes at least one of a name, affiliation, and an address of the participant according to the participant information form of the community for the event.

10. The method of claim 4, further comprising:
requesting download of the data to the data sharing directory through the application installed in the wireless terminal possessed by the participant of the community for the event with reference to the data ID; and
authorizing, by the service platform, the data ID, and then providing the data to the application installed in the wireless terminal possessed by the participant according to the request for the download.

11. The method of claim 1, further comprising:
requesting a generation of a chat room from the service platform by transmitting the community ID and the participant ID through the application installed in the wireless terminal possessed by the participant of the community for the event; and
authorizing, by the service platform, the community ID and the participant ID, generating the chat room according to the request for the generation of the chat room, and providing an ID of the generated chat room to the application installed in the wireless terminal possessed by the participant.

12. The method of claim 1, further comprising:
requesting a leave from the community for the event from the service platform by transmitting the community ID and the participant ID through the application installed in the wireless terminal possessed by the participant of the community for the event; and
authorizing, by the service platform, the community ID and the participant ID, deleting the participant according to the request for the leave, and then providing a result of the request for the leave to the applications installed in the wireless terminal possessed by the participant and a wireless terminal possessed by another participant of the community for the event.
